(19) United States
(12) Patent Application Publication
(10) Pub. No.: US 2026/0321000 A1
(43) Pub. Date: Oct. 15, 2026

(54) PROCESSING CONTROL SYSTEM, PROCESSING CONTROL DEVICE, AND PROCESSING CONTROL METHOD

(71) Applicant: NEC Corporation, Minato-Ku, Tokyo (JP)

(72) Inventors: Koichi NIHEI, Tokyo (JP); Masaharu MORIMOTO, Tokyo (JP); Hayato ITSUMI, Tokyo (JP); Florian BEYE, Tokyo (JP); Takanori IWAI, Tokyo (JP); Seiya SHIBATA, Tokyo (JP)

(73) Assignee: NEC Corporation, Minato-Ku, Tokyo (JP)

(21) Appl. No.: 19/119,152

(22) PCT Filed: Oct. 14, 2022
(86) PCT No.: PCT/JP2022/038457

§ 371 Date: Apr. 8, 2025

(51) Int. Cl. G06V 10/96; G06V 10/70; G06V 10/94

(52) U.S. Cl. CPC G06V 10/96; G06V 10/87; G06V 10/95

(57) ABSTRACT

A processing control system (100) includes: a selection means (101) configured to select, for each of at least one piece of analysis target data which has been acquired by at least one first processing unit, a division method for analysis of the analysis target data in accordance with a computation capacity of the first processing unit; and a processing control means (102) configured to control the at least one first processing unit and the second processing unit in accordance with a selection result.

### TECHNICAL FIELD

The present invention relates to a processing control system, a processing control apparatus, and a processing control method.

### BACKGROUND ART

There is a technology for analyzing analysis target data that has been acquired by a camera, a sensor, or the like, and for example, checking, from a remote location, a target object such as a person or an object and a motion thereof. Such a technology has been in use. For example, Patent Literature 1 discloses that in a system that includes one or more image sensors and one or more operation terminals, on-site operators etc. access an image sensor with use of respective different operation terminals and view an image of a target object which has been acquired by the image sensor and a processing result which has been acquired by each of the at least one first processing unit 20 by analysis in the image sensor.

### CITATION LIST

### Patent Literature

### Patent Literature 1

PCT International Publication No. WO 2021/161647

### SUMMARY OF INVENTION

### Technical Problem

However, in a case where analysis target data increases in data amount due to improved resolution of a camera or in a case where computation cost increases due to advanced analysis content, the analysis may not be sufficiently performed. In light of this, in order to perform efficient analysis, a technology for controlling an analysis process is demanded. Although disclosing that the image sensor adaptively changes, in accordance with performance of an operation terminal and/or the like, for example, resolution of a transmission image to be transmitted to the operation terminal, Patent Literature 1 does not disclose any technology for controlling an analysis process.

An example aspect of the present invention is attained in view of the above problem. An example object of an example aspect of the present invention is to provide a processing control system, a processing control apparatus, and a processing control method each of which makes it possible to control an analysis process in order to perform efficient analysis.

### Solution to Problem

A processing control system in accordance with an aspect of the present invention is a processing control system that controls at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control system including: a selection means configured to select, for each of the at least one piece of analysis target data which has been acquired by each of the at least one first processing unit, a division method for analysis of the analysis target data in accordance with a computation capacity of the first processing unit; and a processing control means configured to control each of the at least one first processing unit and the second processing unit so that each piece of the analysis target data is analyzed according to the division method which has been selected by the selection means.

A processing control apparatus in accordance with an aspect of the present invention is a processing control apparatus that controls at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control apparatus including: a selection unit configured to select, for each of the at least one piece of analysis target data which has been acquired by each of the at least one first processing unit, a division method for analysis of the analysis target data in accordance with a computation capacity of the first processing unit; and a processing control unit configured to control each of the at least one first processing unit and the second processing unit so that each piece of the analysis target data is analyzed according to the division method which has been selected by the selection unit.

A processing control method in accordance with an aspect of the present invention is a processing control method for controlling at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control method including: selecting, for each of the at least one piece of analysis target data which has been acquired by each of the at least one first processing unit, a division method for analysis of the analysis target data in accordance with a computation capacity of the first processing unit; and controlling each of the at least one first processing unit and the second processing unit so that each piece of the analysis target data is analyzed according to the division method which has been selected.

### Advantageous Effects of Invention

An example aspect of the present invention makes it possible to control an analysis process in order to perform efficient analysis.

### BRIEF DESCRIPTION OF DRAWINGS

FIG. 1 is a block diagram illustrating a configuration example of a processing control system in accordance with a first example embodiment.

FIG. 2 is a block diagram illustrating a configuration example of a processing system that is controlled by the processing control system.

FIG. 3 is a flowchart showing an example of a flow of a processing control method in accordance with the first example embodiment.

FIG. 4 is a block diagram illustrating a configuration example of a processing control apparatus in accordance with the first example embodiment.

FIG. 5 is a block diagram illustrating configuration examples of a processing control system and of a processing system in accordance with a second example embodiment.

FIG. 6 is a schematic diagram illustrating an example of extraction of analysis target data.

FIG. 7 is a table showing an example of information which is referred to for selecting a division method.

FIG. 8 is a block diagram illustrating configuration examples of a processing control system and of a processing system in accordance with a third example embodiment.

FIG. 9 is a block diagram illustrating configuration examples of a processing control system and of a processing system in accordance with a fourth example embodiment.

FIG. 10 is a block diagram illustrating configuration examples of a processing control system and of a processing system in accordance with a fifth example embodiment.

FIG. 11 is a block diagram illustrating a configuration example of a computer.

### DESCRIPTION OF EMBODIMENTS

### First Example Embodiment

The following description will discuss in detail a first example embodiment of the present invention, with reference to drawings. The present example embodiment is a basic form of example embodiments described later.

### (Configuration of Processing Control System)

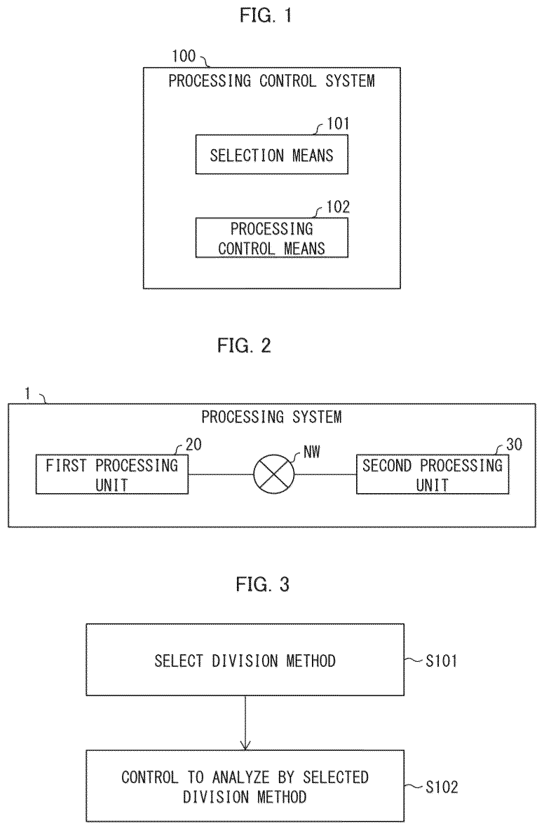

The following description will discuss a processing control system in accordance with the present example embodiment, with reference to FIG. 1. FIG. 1 is a block diagram illustrating a configuration example of a processing control system 100 in accordance with a first example embodiment. The processing control system 100 includes a selection means 101 and a processing control means 102, and controls a processing system.

FIG. 2 is a block diagram illustrating a configuration example of the processing system that is controlled by the processing control system. A processing system 1 includes at least one first processing unit 20 and a second processing unit 30. In FIG. 2, for ease of viewing, a configuration including one first processing unit 20 is illustrated, but the configuration may include a plurality of first processing units 20.

Each of the at least one first processing unit 20 is connected to, for example, a camera, a sensor of light detection and ranging (LiDAR), and/or the like, and receives at least one piece of analysis target data from the camera, the sensor, and/or the like. In an example, the analysis target data may be video data which was obtained by capturing an image by the camera. The video data only needs to include an analysis target in an angle of view of a video. Examples of the analysis target include a worker (person) who works in a construction site, a work apparatus (object), and behaviors (motions) of the worker and the work apparatus. Further, the analysis target data may be sensing data that is obtained by detecting, with use of the sensor, an analysis target.

Further, the first processing unit 20 may be connected to a plurality of cameras, sensors, and/or the like, and may acquire a plurality of pieces of analysis target data. Alternatively, the first processing unit 20 may acquire a plurality of pieces of analysis target data from a single camera, a single sensor, or the like. In this case, the first processing unit 20 may acquire a plurality of pieces of analysis target data by extracting the plurality of pieces of analysis target data from data that was acquired by the single camera, the single sensor, or the like.

The first processing unit 20 and the second processing unit 30 may each be constituted by at least one computer. The first processing unit 20 and the second processing unit 30 can communicate with each other via a network NW, and divide an analysis process of the analysis target data between the first processing unit 20 and the second processing unit 30. The network NW may be wireless or wired. In a case where the network NW is wireless, a wireless communication system such as Wi-Fi, LTE, 4G, 5G, or the like may be employed.

In an example aspect, the first processing unit 20 may be an edge processing unit and the second processing unit 30 may be a cloud processing. In the present specification, the term “edge” refers to a place where data is collected. The first processing unit 20, which serves as an edge processing unit, is an information processing apparatus (computer) or an information processing apparatus group which is installed in a place where an analysis target is present (for example, a construction site or a factory) or a place surrounding the place where the analysis target is present. The first processing unit 20 acquires video data from an imaging apparatus 10 that is installed in the place where the analysis target is present. The first processing unit 20 may be integral with the camera, the sensor, and/or the like. Further, in the present specification, the term “cloud” refers to a place where data is processed, stored, and/or the like. The second processing unit 30, which serves as a cloud processing unit, may be an information processing apparatus (computer) or an information processing apparatus group which is installed in a place, such as a data center or a server farm, where a large calculation resource can be provided. Note that the second processing unit 30 only needs to be located at a place that is connected with the first processing unit 20 via a network, and may be, for example, a calculation resource (e.g., multi-access edge computing (MEC)) which is connected to a base station that supports 5G or the like or a server (on-premises server) which is installed at a site office or the like.

The first processing unit 20 may generate an analysis result by carrying out an analysis process on at least one or some of the at least one piece of analysis target data acquired. The first processing unit 20 may calculate a feature for at least one or some of the at least one piece of analysis target data acquired, and transmit, to the second processing unit 30 via the network NW, the feature thus calculated. The first processing unit 20 may transmit, to the second processing unit 30 via the network NW, at least one or some of the at least one piece of analysis target data acquired. Note that in transmitting the feature or the analysis target data to the second processing unit 30, the first processing unit 20 may or may not carry out a compression process or an encryption process on the feature or the analysis target data before transmitting, to the second processing unit 30, the feature or the analysis target data.

The second processing unit 30 receives the feature or the analysis target data that has been transmitted from the first processing unit 20, and carries out an analysis process after carrying out a decryption process as needed.

Examples of the analysis process include detection, recognition, tracking, and time-series analysis of the analysis target (object and/or person) on the basis of the analysis target data. For this analysis process, a trained model may be used. The first processing unit 20 and/or the second processing unit 30 may use a trained model.

The processing control system 100 (the selection means 101 and the processing control means 102) controls the processing system 1 (that is, the first processing unit 20 and the second processing unit 30), and divides analysis of the analysis target data between the first processing unit 20 and the second processing unit 30. Note that the processing control system 100 does not need to cause the processing system 1 to analyze analysis target data for which the processing control system 100 has determined that analysis is unnecessary.

The analysis of the analysis target data can be divided between the first processing unit 20 and the second processing unit 30 in various modes. Examples of the modes include: a mode in which the first processing unit 20 which has acquired analysis target data carries out all of an analysis process of the analysis target data; a mode in which the first processing unit 20 which has acquired analysis target data carries out an analysis process of the analysis target data to some extent and the second processing unit 30 carries out remaining part of the analysis process; and a mode in which the first processing unit 20 performs minimum necessary processing such as compression and the second processing unit 30 carries out all of an analysis process of the target analysis data. By using a different method among the above division methods depending on a situation, it is possible to efficiently carry out the analysis process in accordance with the situation.

It should be noted here that the selection means 101 selects a division method for each of the at least one piece of the analysis target data which has been acquired by each of the at least one first processing unit 20. More specifically, the selection means 101 can select a division method for analysis of the analysis target data in accordance with a computation capacity of the first processing unit 20. For example, the selection means 101 may select a division method so that in a case where the computation capacity of the first processing unit 20 is higher, the first processing unit 20 performs more analysis on the analysis target data which the first processing unit 20 has acquired. It should be noted here that the computation capacity of the first processing unit 20 refers to an index of a capacity for carrying out the analysis process, and is based on computation resources, such as a CPU, a GPU, a memory, and the like which the first processing unit 20 includes.

In general, the second processing unit 30 has a much larger computation capacity than the first processing unit 20. On the other hand, the first processing unit 20 can instantly process the analysis target data acquired. Therefore, it is more efficient as a whole that the analysis process which the first processing unit 20 is incapable of performing is performed in the second processing unit 30. In other words, how to divide the analysis process for efficiency depends on the computation capacity of the first processing unit 20. Therefore, efficient analysis can be achieved in a case where the selection means 101 selects a division method in accordance with the computation capacity of the first processing unit 20 which has acquired the analysis target data.

The processing control means 102 controls each of the at least one first processing unit 20 and the second processing unit 30 so that each piece of the analysis target data is analyzed according to the division method which has been selected by the selection means 101.

The processing control means 102 may be provided in, for example, the second processing unit 30. Then, the processing control means 102 may directly control the second processing unit 30 and in addition, control the at least one first processing unit 20 through communication between the second processing unit 30 and the at least one first processing unit 20. Alternatively, the processing control means 102 may be provided in, for example, an apparatus that can communicate with the at least one first processing unit 20 and the second processing unit 30. Then, the processing control means 102 may control each of the at least one first processing unit 20 and the second processing unit 30 through communication between the apparatus and each of the at least one first processing unit 20 and between the apparatus and the second processing unit 30. Alternatively, the processing control means 102 may be provided in, for example, each of the at least one first processing unit 20 and the second processing unit 30. Then, the processing control means 102 may directly control each of the first processing unit 20 and the second processing unit 30. Alternatively, the processing control means 102 may be provided in, for example, each of the at least one first processing unit 20. Then, the processing control means 102 may directly control each of the at least one first processing unit 20 and in addition, control the second processing unit 30 through communication between the first processing unit 20 and the second processing unit 30.

As described above, in the processing control system 100 in accordance with the present example embodiment, the division method is selected on the basis of the computation capacity of the first processing unit. This allows the processing control system 100 in accordance with the present example embodiment to efficiently carry out an analysis process by the first processing unit 20 and the second processing unit 30.

### (Flow of Processing Control Method)

The following description will discuss a processing control method S100 in accordance with the present example embodiment, with reference to FIG. 3. FIG. 3 is a flowchart showing a flow of the processing control method S100 in accordance with the first example embodiment.

In step S101, the selection means 101 selects a division method for each of at least one piece of analysis target data which has been acquired by each of the at least one first processing unit 20. More specifically, the selection means 101 selects, for each of the at least one piece of analysis target data which has been acquired by each of the at least one first processing unit 20, a division method for analysis of the analysis target data in accordance with the computation capacity of the at least one first processing unit.

In step S102, the processing control means 102 controls each of the at least one first processing unit 20 and the second processing unit 30 so that each piece of the analysis target data is analyzed according to the division method which has been selected by the selection means 101.

As described above, in the processing control method S100 in accordance with the present example embodiment, the division method is selected on the basis of the computation capacity of the first processing unit. This allows the processing control system 100 in accordance with the present example embodiment to efficiently carry out an analysis process by the first processing unit 20 and the second processing unit 30.

### (Configuration of Processing Control Apparatus)

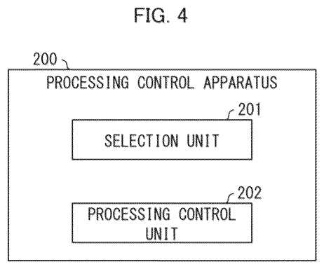

The following description will discuss a processing control apparatus 200 in accordance with the present example embodiment, with reference to FIG. 4. FIG. 4 is a block diagram illustrating a configuration example of the processing control apparatus 200 in accordance with the first example embodiment. The processing control apparatus 200 includes a selection unit 201 and a processing control unit 202, and controls the processing system 1 (the at least one first processing unit 20 and the second processing unit 30).

The selection unit 201 has a function equivalent to that of the selection means 101, and selects, for each of at least one piece of analysis target data which has been acquired by each of the at least one first processing unit, a division method in accordance with the computation capacity of the at least one first processing unit 20. The processing control unit 202 has a function equivalent to that of the processing control means 102, and controls each of the at least one first processing unit 20 and the second processing unit 30 so that each piece of the analysis target data is analyzed according to the division method which has been selected by the selection unit 201.

The selection unit 201 and the processing control unit 202 may be a computer apparatus in which processing is performed by causing the processor to execute a program stored in a memory. For example, the selection unit 201 and the processing control unit 202 may be a single computer apparatus, a computer apparatus group in which a plurality of computer apparatuses operate in cooperation with each other, or a server apparatus group in which a plurality of server apparatuses operate in cooperation with each other. The processing control apparatus 200 makes it possible to obtain an effect equivalent to that of the processing control system 100.

### Second Example Embodiment

The following description will discuss in detail a second example embodiment of the present invention, with reference to drawings. Note that components having the same functions as those described in the first example embodiment are denoted by the same reference numerals, and descriptions thereof will be omitted as appropriate.

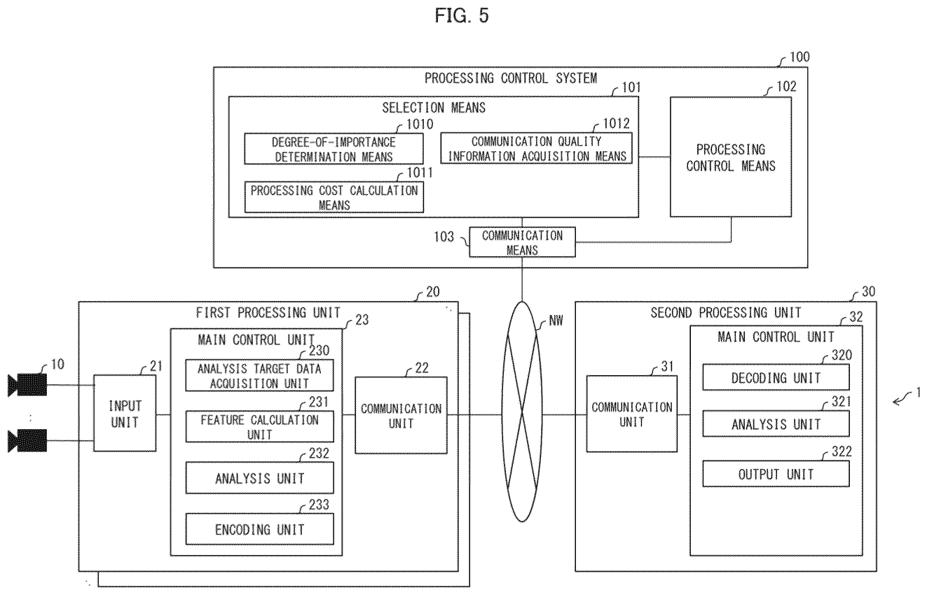

FIG. 5 is a block diagram illustrating configuration examples of a processing system 100 and of a processing system 1 in accordance with the second example embodiment. The processing control system 100 controls the processing system 1. The processing system 1 in accordance with the present example embodiment includes at least one first processing unit 20 and a second processing unit 30 which is connected with the at least one first processing unit 20 via a network NW. The first processing unit 20 is connected to at least one camera 10.

The camera 10 is an imaging apparatus that captures an image of an analysis target, and generates video data. As described above, the analysis target is, for example, a worker (person) who works in a construction site, a work apparatus (object), and behaviors (motions) of the worker and the work apparatus. The camera 10 only needs to be installed to be capable of capturing images of these analysis targets. Each of the at least one first processing unit 20 is connected to at least one camera 10. Basically, a single camera 10 is connected to only one first processing unit 20.

### (First Processing Unit)

The first processing unit 20 includes an input unit 21, a communication unit 22, and a main control unit 23. The input unit 21 receives video data that is captured by each camera 10 which is connected to the first processing unit 20. The communication unit 22 exchanges data with the second processing unit 30 and the processing control system 100 via the network NW.

The main control unit 23 includes an analysis target data acquisition unit 230, a feature calculation unit 231, an analysis unit 232, and an encoding unit 233.

The analysis target data acquisition unit 210 acquires at least one piece of analysis target data. The analysis target data acquisition unit 210 may acquire, as the analysis target data, a whole of each piece of the video data which has been inputted to the input unit 21. Alternatively, the analysis target data acquisition unit 210 may acquire as described below, as the analysis target data, one or more regions that are extracted from each piece of the video data.

In an example aspect, the analysis target data acquisition unit 210 extracts one or more regions from the video data that has been inputted to the input unit 21, and acquires each of the regions as the analysis target data. A method of extracting one or more regions from video data is not particularly limited. For example, the analysis target data acquisition unit 210 may perform object detection on the video data and acquire, as the analysis target data, a region where an object is detected. At this time, the analysis target data acquisition unit 210 may perform object detection using a trained model for object detection. Further, the analysis target data acquisition unit 210 may divide the video data into predetermined grids and acquire each divisional region as the analysis target data.

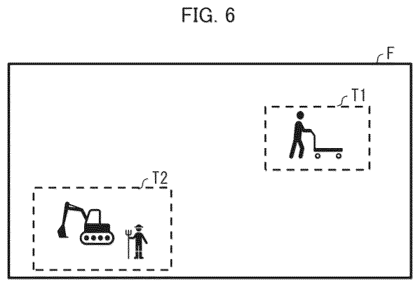

FIG. 6 is a diagram illustrating an example of the analysis target data which is acquired by the analysis target data acquisition unit 210. In the example illustrated in FIG. 6, the analysis target data acquisition unit 210 acquires, as analysis target data pieces T1 and T2, respective regions that have been detected by the object detection for a frame image F of the video data. The regions each may be selected to include a plurality of objects as in T2.

The feature calculation unit 231 calculates a feature of the analysis target data. A method of calculating a feature of analysis target data is not particularly limited. In an example aspect, the feature calculation unit 231 may calculate the feature from the analysis target data with use of a trained model having a convolution layer. Further, in an example aspect, in a case where the trained model used by the analysis target data acquisition unit 210 for object detection is configured to output identification result information (class information) of an object, the identification result information may be used as the feature. Further, the object which has been detected or identified may be tracked, and an identifier which indicates whether or not respective objects that appear in two consecutive frame images are identical to each other may be added to the feature.

The analysis unit 232 analyzes the analysis target data and generates an analysis result. In the present specification, the term “analysis” refers to detecting, in an analysis target, the occurrence of an event to be detected or the presence of an object to be detected. For example, in a case where the analysis target is a worker (person) who works in a construction site, a work apparatus (object), a behavior (motion) of the worker or the work apparatus, or the like, examples of the analysis result include the following detection results: the occurrence of events such as inefficient work, a mistake in a procedure, and a dangerous action; and the presence of a specific object such as a specific worker or a specific work apparatus. For example, the analysis target data T2 illustrated in FIG. 6 may be analyzed as a dangerous action of coming close to a heavy machine.

The analysis unit 232 can, for example, perform analysis using a trained model which has been trained in advance so as to output an analysis result. A training method for preparing the trained model for use in the analysis is not particularly limited. For example, training may be performed using, as training data, a pair of (i) an event that is to be detected and (ii) analysis target data that indicates an analysis target in a case where the event is occurring. Alternatively, reinforcement learning may be performed in such a manner that a reward is given in a case where an event to be detected could be detected. Further, as an input to the trained model, the analysis target data may be used or the feature calculated by the feature calculation unit 231 may be used.

The encoding unit 233 performs a process(es) such as a compression process and/or an encryption process for data (the analysis target data, the feature, and the like) that is to be transmitted via the communication unit 22.

### (Second Processing Unit)

The second processing unit 30 includes a communication unit 31 and a main control unit 32. The communication unit 31 exchanges data with each of the at least one first processing unit 20 and the processing control system 100 via the network NW.

The main control unit 32 includes a decoding unit 320, an analysis unit 321, and an output unit 322.

The decoding unit 320 performs a process(es) such as an expansion process and/or a decoding process on the data that has been received via the communication unit 31, and provides the data to the analysis unit 321 or the output unit 322.

The analysis unit 321 analyzes the analysis target data or the feature that has been received via the communication unit 31, and generates an analysis result. The analysis unit 321, like the analysis unit 232, can perform analysis using, for example, a trained model which has been trained in advance so as to output the analysis result. The trained model that is used by the analysis unit 321 may or may not be the same as the trained model that is used by the analysis unit 232.

The output unit 322 performs a process in accordance with the analysis result of the analysis unit 321 or the analysis result of the analysis unit 232 that has been received via the communication unit 31. For example, the output unit 322 may notify, via the communication unit 31, a predetermined notification destination of the analysis result described above. Alternatively, the output unit 322 may transmit a warning signal to a predetermined notification destination via the communication unit 31 in a case where the analysis result described above indicates a predetermined event.

Further, the analysis result (work content) may be displayed, together with a video that has been analyzed, for example, on a terminal which is held by a supervisor (for example, a site supervisor) or on a large display at a monitoring center. Such display is performed through communication from the first processing unit 20 or the second processing unit 30, or the like. As a result, the supervisor can check the video of the work site together with the analysis result of the work, accurately ascertain a situation of the work, and give a precise instruction to the site.

The network NW may be wireless or wired. A communication bandwidth in the network NW may be assigned in advance to each of the at least one first processing unit 20. Alternatively, the network NW may detect or predict communication quality between each of the at least one first processing unit 20 and the second processing unit 30, and provide, to the processing control system 100, communication quality information that indicates the communication quality.

### (Processing Control System)

The processing control system 100 includes a selection means 101, a processing control means 102, a communication means 103, and a communication means 103, and controls the processing system 1. The communication means 103 exchanges data with each of the at least one first processing unit 20 and the second processing unit 30 via the network NW.

The selection means 101 includes a degree-of-importance determination means 1010, a processing cost calculation means 1011, and a communication quality information determination means 1012. As described above, the selection means 101 selects a division method for each of the at least one piece of analysis target data which has been acquired by each of the at least one first processing unit 20. Details of how the selection means 101 selects the division method will be described later.

The degree-of-importance determination means 1010 determines a degree of importance of each piece of the analysis target data. In the present specification, the term “degree of importance” refers to need for analysis. For analysis target data in which it is highly likely that an event that is a detection target of analysis is occurring or an object that is a detection target of analysis is present, the degree of importance may be determined to be high. The “degree of importance” can also be referred to as “degree of attention”, “need for close observation”, or the like. Examples of events having a high degree of importance include, but are not limited to, a motion that matches a process, a motion that does not match the process, and a motion that has a high degree of danger. Examples of an object that has a high degree of importance include, but are not limited to, humans and heavy machines. Further, the degree of importance may be determined on the basis of whether a detection target is detectable or not. For example, the degree of importance of a person or an object that appears very small and difficult to detect in a video may be decreased. An expression method of the degree of importance is not particularly limited. For example, the degree of importance may be expressed by two values of “0” (low degree of importance) and “1” (high degree of importance), or may be expressed by multiple values including 3 or more values (for example, high, medium, and low), or consecutive numerical values.

The degree-of-importance determination means 1010, for example, may determine that a motion shown in analysis target data has a high degree of importance in a case where the motion shown in the analysis target data indicates the above-described event, but may make such determination with use of a trained model. For example, the degree-of-importance determination means 1010 may determine, with use of a trained model which receives, as input, the feature of each piece of the analysis target data and outputs the degree of importance. In this case, the feature of each piece of the analysis target data may be obtained by calculation by the feature calculation unit 231 of the first processing unit 20. The degree-of-importance determination means 1010 may acquire, from the first processing unit 20, the feature of each piece of the analysis target data via the communication means 103. A training method for preparing a trained model to which the feature of each piece of the analysis target data is inputted and from which the degree of importance is outputted is not particularly limited. Training may be performed using, as training data, the analysis target data for training in which the degree of importance is labeled. Further, the degree-of-importance determination means 1010 may determine the degree of importance with use of a trained model to which the video data is inputted and from which the degree of importance is outputted. In this case, the degree-of-importance determination means 1010 may acquire, as the video data, the analysis target data itself from the first processing unit 20. The degree-of-importance determination means 1010 may alternatively acquire, from the first processing unit 20, video data which has a reduced frame rate or a decreased image quality of a video of the analysis target data in order to reduce a communication amount.

Further, for example, the degree-of-importance determination means 1010 may determine the degrees of importance of respective portions of analysis target data, by inputting, to the trained model, input data which has been obtained by calculating features of the respective portions of the analysis target data and combining the features. The trained model to be used may (i) receive the input data that is obtained by combining the features of the respective portions, (ii) generate, on the basis of the input data, relevance information that indicates relation between the features of the respective portions, and (iii) output the degrees of importance of the respective regions on the basis of the relevance information and the input data. In an example aspect, the relevance information indicates, with respect to the degree of importance of each of the regions, how much regions other than the (each) region are related. In other words, the relevance information indicates, for each of the regions, the relation between the regions in such a manner that: a region necessary for determining the degree of importance of the each region has a high relevance; and a region unnecessary for determining the degree of importance of the specific region has a low relevance. Examples of such relevance information include attention weight that is used in an attention mechanism such as a self-attention mechanism. The trained model includes, for example, at least one layer for generating the relevance information on the basis of the input data and at least one layer for generating the degree of importance of each region on the basis of the relevance information and the input data. The trained model may be obtained by training by, for example, reinforcement learning using: an input image for training to which a label indicating an analysis result is attached; and an analysis engine that performs analysis of the input image using the degree of importance.

The processing cost calculation means 1011 calculates or predicts each of (i) and (ii) in a case where each piece of the analysis target data is analyzed by each division method: (i) computation cost in the first processing unit 20; and (ii) communication cost between the first processing unit 20 and the second processing unit 30. The computation cost in the first processing unit 20 is, for example, a value that indicates a ratio of a computation capacity of the first processing unit 20 which is used for the analysis target data, with respect to the computation capacity of the first processing unit 20. The computation cost may be expressed by a relative value in a case where the computation capacity of the first processing unit 20 is “1”. The communication cost between the first processing unit 20 and the second processing unit 30 is, for example, a value that indicates an amount of data that is carried between the first processing unit 20 and the second processing unit 30. The communication cost may be expressed by a bit rate (Mbps) of the data. Further, the communication cost may be expressed by a required resource amount such as the number of resource blocks in LTE or 5G. In this case, even in a case where bit rates of the data are the same, the required resource amount is different between an environment in which communication quality is good and an environment in which communication quality is poor. In a case where the processing cost calculation means 1011 predicts each cost, each cost may be predicted by using a trained model to which the feature of the analysis target data is inputted and from which a predicted value of each cost is outputted.

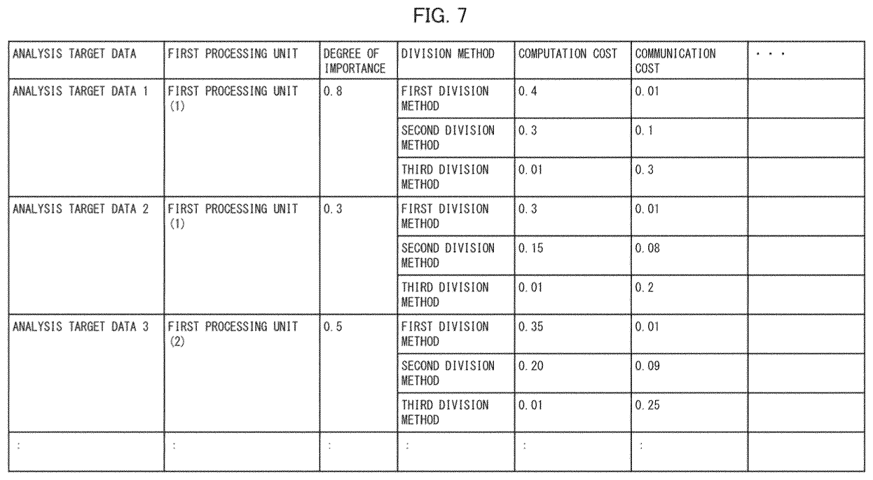

FIG. 7 is a table showing an example of information which the selection means 101 refers to in order to select a division method, for each piece of the analysis target data which has been acquired by each of the at least one first processing unit 20. This table shows, for each piece of the analysis target data, the first processing unit, the degree of importance, and the computation cost and the communication cost in a case where analysis is performed by each division method. How the selection means 101 selects a division method with reference to this table will be described later.

The communication quality information acquisition means 1012 acquires communication quality information that indicates the communication quality between each of the at least one first processing unit 20 and the second processing unit 30. Examples of the communication quality information include communication throughput, modulation and coding scheme (MCS) indexes, and signal to interference plus noise ratios (SINR), and the communication quality information may be a predicted value of these. Further, in a case where the predicted value is used as the communication quality information, the worst value (lowest value) in a predicted fluctuation range may be used.

The processing control means 102 controls each of the at least one first processing unit 20 and the second processing unit 30 so that each piece of the analysis target data is analyzed according to the division method which has been selected by the selection means 101. In an example aspect, the processing control means 102 may perform the above control by transmitting, to each of the at least one first processing unit 20 and the second processing unit 30 via the communication means 103, information that specifies the analysis target data and information that indicates the division method which has been selected for the specified analysis target data.

Further, in another example aspect, the processing control means 102 may select a division method so as to switch which one of the at least one first processing unit 20 and the second processing unit 30 analyzes the analysis target data. At this time, the processing control means 102 may select the division method on the basis of a predicted processing load of the analysis target data in the first processing unit 20 and a predicted communication bandwidth between the first processing unit 20 and the second processing unit 30. The processing control means 102 may also determine, on the basis of the predicted communication bandwidth, an analysis target data portion to be discarded in the analysis target data. In a case where a state in which the analysis target data is not processed is switched to a state in which the analysis target data is processed, the processing control means 102 may also cause the first processing unit 20 and the second processing unit 30 to complement, in a unit frame set, a frame which was being processed before the switching. The processing control means 102 may also cause one of the first processing unit 20 and the second processing unit 30 which is not analyzing the analysis target data to perform buffering of the analysis target data. Then, at the time when the processing unit that was not processing the analysis target data is switched to process the analysis target data, the processing control means 102 may cause that processing unit to analyze the analysis target data with use of the data which has been subjected to the buffering. Note that the processing control means 102 may execute the above-described discard processing, complementing processing, and buffering processing on the basis of, for example, the degree of importance of the analysis target data, a degree of reliability of processing of the analysis target data, a communication bandwidth which is assigned for transmission of the analysis target data, and/or the like. Note that the degree of reliability may be an index that indicates a level of certainty of a predicted analysis result. The degree of reliability may be, for example, a confidence value that is outputted from the trained model which has performed analysis.

### (Selection of Division Method)

Next, the following description will discuss details of selection of the division method by the selection means 101. The selection means 101 in the present example embodiment selects a division method from among the following division methods 1 to 3.
Division method 1: The first processing unit 20 which has acquired analysis target data generates an analysis result for the analysis target data.
Division method 2: The first processing unit 20 which has acquired analysis target data calculates a feature of the analysis target data; the feature is transmitted from the first processing unit 20 to the second processing unit 30; and the second processing unit 30 generates, from the feature, an analysis result for the analysis target data.
Division method 3: Analysis target data is transmitted from the first processing unit 20 which has acquired the analysis target data to the second processing unit; and the second processing unit 30 generates an analysis result from the analysis target data.

In one perspective, the division methods 1 to 3 differ from each other in mode of division of an analysis process of analysis target data between the first processing unit 20 which has acquired the analysis target data and the second processing unit 30. In other words, the division method 1 is a mode in which all the analysis process of the analysis target data is carried out in the first processing unit 20 which has acquired the analysis target data. The division method 2 is a mode in which the analysis process of the analysis target data is performed by dividing the analysis process between the first processing unit 20 which has acquired the analysis target data and the second processing unit 30. The division method 3 is a mode in which the first processing unit 20 performs minimum necessary processing such as compression, and the second processing unit 30 carries out all the analysis process of the analysis target data. By using a different method among the above division methods depending on a situation, it is possible to efficiently carry out the analysis process in accordance with the situation.

In an example embodiment, the processing control system 100 may cause the processing system 1 to analyze each piece of analysis target data by a division method which is selected from at least two selected from the group consisting of the division methods 1 to 3. In other words, the processing control system 100 may cause the processing system 1 to analyze each piece of analysis target data by a division method which is selected from the group consisting of the division methods 1 to 3. Alternatively, the processing control system 100 may cause the processing system 1 to analyze each piece of analysis target data by: a division method which is selected from the group consisting of the division methods 1 and 2; a division method which is selected from the group consisting of the division methods 1 and 3; or a division method which is selected from the group consisting of the division methods 2 and 3.

The selection means 101 selects a division method for each of at least one piece of analysis target data which has been acquired by each of the at least one first processing unit 20. More specifically, the selection means 101 selects, for each of at least one piece of analysis target data which has been acquired by each of the at least one first processing unit 20, a division method from the group consisting of at least two division methods among the following division methods: a first division method in which the first processing unit is caused to generate an analysis result of the analysis target data; a second division method in which the first processing unit is caused to calculate a feature of the analysis target data and transmit the feature from the first processing unit to the second processing unit, and the second processing unit is caused to generate the analysis result from the feature; and a third division method in which the first processing unit is caused to transmit the analysis target data to the second processing unit, and the second processing unit is caused to generate the analysis result from the analysis target data.

Constraints to be considered here in selecting the division method are as follows.
Since the video data has a large size, it is impossible in a large-scale system to transmit all camera-captured videos from the first processing unit 20 to the second processing unit 30 due to a limitation of an amount of communication resources.
By performing analysis or calculation of the feature in the first processing unit 20 and transmitting a result the analysis or the calculation to the second processing unit 30, it is possible to reduce the communication amount. However, since there is a limitation to the amount of computation resources of the first processing unit 20, it is impossible for the first processing unit 20 to perform all analysis.
The amount of computation resources necessary for analysis of data obtained from each camera, the amount of communication resources necessary for transmitting data having image quality that allows for analysis by the second processing unit 30, and the communication quality between the first processing unit 20 and the second processing unit 30 changes moment by moment. Therefore, it is necessary to deal with such a change as needed.

In order to select a division method in consideration of the above-described constraints, in an example aspect, the selection means 101 operates as follows.

First, the selection means 101 collects, for each of at least one piece of analysis target data which has been acquired by each of the at least one first processing unit 20, the degree of importance which has been determined by the degree-of-importance determination means 1010 and the computation cost and the communication cost which have been calculated by the processing cost calculation means 1011 for a case where analysis is performed by each of the division methods. FIG. 7 shows an example of information which has been collected by the selection means 101. Note that, in FIG. 7, in order to distinguish between different first processing units 20, the first processing units 20 are described as “first processing unit (1)” and the like.

In an example aspect, the selection means 101 refers to collected information, and first determines analysis target data for which the first division method is selected. At this time, the selection means 101 determines, among the at least one piece of analysis target data which has been acquired by each of the at least one first processing unit 20, analysis target data for which the first division method is selected in such a manner that a total of the computation cost in the first processing unit 20 in a case where the analysis target data is analyzed by the first division method does not exceed an upper limit of the computation cost based on the computation capacity of the first processing unit 20. This makes it possible to prevent the first processing unit 20 from being incapable of completing processing the analysis target data. Note that the upper limit of the computation cost based on the computation capacity of the first processing unit 20 may be the computation capacity of the first processing unit 20 itself or may be a value that is set by taking a margin to some extent.

Further, in an example aspect, the selection means 101 determines a degree of priority of each piece of the analysis target data, and determines, on the basis of the degree of priority which has been determined for each piece of the analysis data, analysis target data for which the first division method is selected. For example, the selection means 101 may select, as analysis target data for which the first division method is selected, pieces of the analysis target data in order from a piece of the analysis target data having a higher degree of priority, in such a manner that the total of the computation cost of those for which the first division method is selected is within a range of not higher than the upper limit of the computation cost based on the computation capacity of the first processing unit 20. This makes it possible to select the first division method in a range in which the first processing unit 20 is capable of performing processing. According to the first division method, since the first processing unit 20 which has acquired the analysis target data performs analysis, the analysis can be performed promptly. Thus, the first division method is advantageous in detecting a more urgent event etc.

The method of determining the degree of priority is not particularly limited. For example, the selection means 101 may determine, for each of the at least one piece of analysis target data which has been acquired by each of the at least one first processing unit 20, the degree of priority on the basis of (i) the computation cost in a case where the analysis target data is analyzed by the first division method and (ii) the degree of importance of the analysis target data. For example, the selection means 101 may determine the degree of priority on the basis of the following formula.

$$Degree of priority = ( α 1 \times degree of importance ) / computation cost ( where α 1 is a predetermined value )$$

For example, in the example of FIG. 7, the selection means 101 preferentially selects, as analysis target data for which the first division method is selected, analysis target data 1 from among the analysis target data which has been acquired by the “first processing unit (1)”. By determining the degree of priority in this manner, it is possible to efficiently perform analysis while the need for the analysis and the computation cost are balanced.

Subsequently, the selection means 101 selects a division method for analysis target data for which the first division method has not been selected among the at least one piece of analysis target data which has been acquired by each of the at least one first processing unit 20. In an example aspect, the selection means 101 may select the second division method or the third division method, on the basis of the communication quality information of each of the at least one first processing unit 20 which the communication quality information acquisition means 1012 has acquired.

In the third division method, the communication amount is larger than that in the second division method. However, by selecting the third division method for analysis target data of the first processing unit 20 that has good communication quality, it is possible to increase utilization efficiency of radio resources. In particular, for example, in a case where a plurality of first processing units 20 each acquire, as the analysis target data, one or more regions of video data which is inputted from the camera 10 and offloads, to the second processing unit 30, data which each of the first processing units 20 was incapable of processing, a first processing unit 20 having good communication quality is prioritized. This makes it possible to increase the utilization efficiency of the radio resources. This allows the analysis process to be efficiently offloaded to the second processing unit 30, so that video data acquired from more cameras 10 can be analyzed.

Note that the selection means 101 may not cause, for example, analysis target data having a low degree of importance to be analyzed, in a case where the total of the communication cost of the analysis target data for which the first division method has not been selected among the at least one piece of analysis target data which has been acquired by each of the at least one first processing unit 20 exceeds the communication bandwidth between the first processing unit 20 and the second processing unit 30.

Although the above description has described the second example embodiment as the processing control system 100, the second embodiment can be a processing control apparatus which is obtained by mounting the processing control system 100 in accordance with the second example embodiment on one apparatus. Further, the processing control system 100 in accordance with the second example embodiment may be operated by a processing control method in accordance with the second example embodiment.

### Third Example Embodiment

The following description will discuss in detail a third example embodiment of the present invention, with reference to drawings. Note that components having the same functions as those described in the first and second example embodiments are denoted by the same reference numerals, and descriptions thereof will be omitted as appropriate.

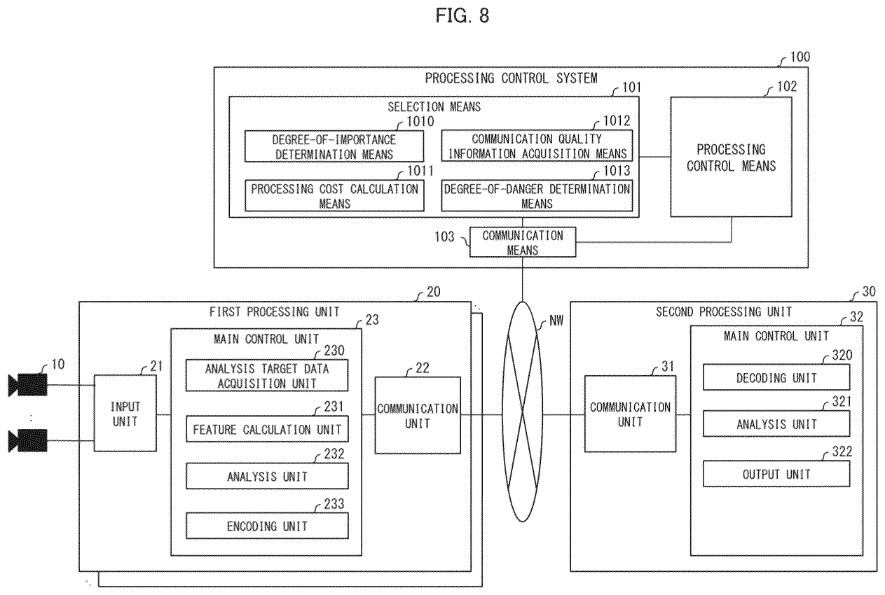

FIG. 8 is a block diagram illustrating configuration examples of a processing control system 100 and of a processing system 1 in accordance with the third example embodiment. The processing control system 100 in accordance with the present example embodiment is different from the processing control system 100 in accordance with the second example embodiment in that the selection means 101 includes a degree-of-danger determination means 1013. Therefore, the following description will discuss a function of the degree-of-danger determination means 1013.

The degree-of-danger determination means 1013 determines a degree of danger which is indicated by each piece of analysis target data. In the present specification, the term “degree of danger” refers to need for quickly performing analysis. For example, a piece of analysis target data indicating that a dangerous even is highly likely to be occurring may be determined to have a high degree of danger. Examples of an event having a high degree of danger include, but are not limited to, people who are at high risk locations (e.g., a person at a high place, a person who is working near a hole which was dug in a site, a person who is working near a heavy machine, and a person who is near a road, a railway, or a high-voltage line), regions where people or equipment and materials are at a high density (which are judged to be at higher danger in a case where the density is higher), and people making large movements (who are judged to be at higher danger than people who are not moving). An expression method of the degree of danger is not particularly limited. For example, the degree of danger may be expressed by two values of “0” (low degree of danger) and “1” (high degree of danger), or may be expressed by multiple values including 3 or more values, or consecutive numerical values.

The degree-of-danger determination means 1013 may determine that the degree of danger is high in a case where, for example, a relation between a person shown in the analysis target data and a surrounding object indicates an event described above. Alternatively, the degree-of-danger determination means 1013, like the degree-of-importance determination means 1010, may make such determination with use of a trained model. For example, the degree-of-danger determination means 1013 may determine the degree of importance with use of a trained model which receives, as an input, a feature of each piece of the analysis target data and outputs the degree of danger. In this case, the feature of each piece of the analysis target data may be obtained by calculation by the feature calculation unit 231 of the first processing unit 20. The degree-of-danger determination means 1013 may acquire, from the first processing unit 20, the feature of each piece of the analysis target data via the communication means 103. A training method for preparing a trained model to which the feature of each piece of the analysis target data is inputted and from which the degree of danger is outputted is not particularly limited. Training may be performed using, as training data, the analysis target data for training in which the degree of danger is labeled.

Then, the selection means 101 collects, for each of at least one piece of analysis target data which has been acquired by each of the at least one first processing unit 20, the degree of danger which has been determined by the degree-of-danger determination means 1013 in addition to the degree of importance which has been determined by the degree-of-importance determination means 1010 and the computation cost and the communication cost which have been calculated by the processing cost calculation means 1011 for a case where analysis is performed by each of division methods.

Further, the selection means 101 may determine the degree of priority for each of the at least one piece of analysis target data which has been acquired by each of the at least one first processing unit 20, on the basis of the computation cost in a case where the analysis target data is analyzed by the first division method, and the degree of importance of the analysis target data and the degree of danger indicated by the analysis target data. For example, the selection means 101 may determine the degree of priority on the basis of the following equation.

$$Degree of priority = ( α 1 \times degree of importance ) \times ( α 2 \times degree of danger ) / computation cost ( where α 1 and α 2 are each a predetermined value )$$

By determining the degree of priority in this manner, the first processing unit 20 detects a dangerous action for which an alert needs to be immediately given to that person or a manager. This makes it possible to prevent a communication delay and reduce, for example, a delay until issue of the alert.

Note that, as described above, the degree-of-danger determination means 1013 may be provided in each of the at least one first processing unit 20 independently of the selection means 101. In that case, in a case where it is determined by the degree-of-danger determination means 1013 of the first processing unit 20 that there is a high degree of danger indicated by a certain piece of analysis target data, that piece of analysis target data may be analyzed in the first processing unit 20 (by the first division method) regardless of control of the processing control means 102.

Although the above description has described the third example embodiment as the processing control system 100, the third embodiment can be a processing control apparatus which is obtained by mounting the processing control system 100 in accordance with the third example embodiment on one apparatus. Further, the processing control system 100 in accordance with the third example embodiment may be operated by a processing control method in accordance with the third example embodiment.

### Fourth Example Embodiment

The following description will discuss in detail a fourth example embodiment of the present invention, with reference to drawings. Note that components having the same functions as those described in the first, second, and third example embodiments are denoted by the same reference numerals, and descriptions thereof will not be repeated.

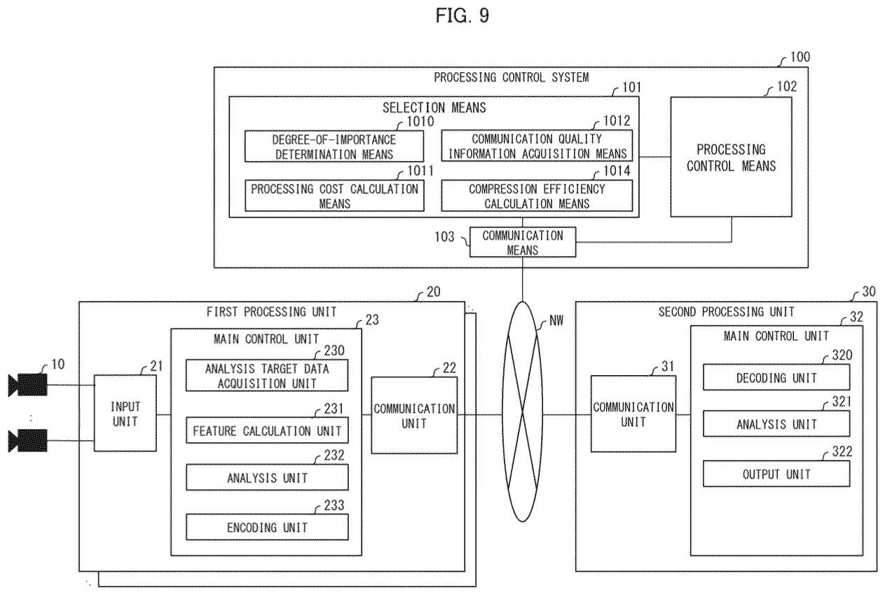

FIG. 9 is a block diagram illustrating configuration examples of a processing control system 100 and of a processing system 1 in accordance with the fourth example embodiment. The processing control system 100 in accordance with the present example embodiment is different from the processing control system 100 in accordance with the second example embodiment in that the selection means 101 includes a compression efficiency calculation means 1014. Therefore, the following description will discuss a function of the compression efficiency calculation means 1014.

The compression efficiency calculation means 1014 calculates compression efficiency of each piece of analysis target data. In the present specification, the term “compression efficiency” refers to an index that indicates how much the analysis target data can be compressed by a compression process, and may be a predicted value.

For example, the compression efficiency tends to decrease in the following cases: a case where a video indicated by the analysis target data shows a state in which it is raining or snowing; a case where the video shows a state in which an object is moving largely; and a case where the video shows a state in which an object is randomly moving. In view of the above, in an example aspect, the compression efficiency calculation means 1014 determines whether or not the analysis target data corresponds to any one of a state in which it is raining or snowing, a state in which an object is largely moving, and a state in which an object is randomly moving. Then, in a case where the analysis target data does not correspond to any of the above states, the compression efficiency calculation means 1014 sets the compression efficiency to, for example, 1. On the other hand, in a case where the analysis target data corresponds to any of these states, the compression efficiency calculation means 1014 may set the compression efficiency to, for example, a value between 0 and 1 in accordance with an amount of rain or snow or an amount of movement.

Further, for analysis target data which shows an outdoor state, the compression efficiency calculation means 1014 may determine, with reference to weather information, whether or not it is raining or snowing. In an example aspect, the compression efficiency calculation means 1014 may set, for analysis target data corresponding to a region which shows an indoor state, the compression efficiency to, for example, 1 in accordance with an imaging range of a camera 10, and may set, for analysis target data corresponding to a region which shows an outdoor state, the compression efficiency between, for example, 0 and 1 in the case of raining or snowing with reference to weather information.

Further, the compression efficiency may be calculated with reference to a past actually measured value or the like. In an example aspect, the compression efficiency calculation means 1014 may acquire a compressed bit rate in an encoding unit 233 of a first processing unit 20 and predict the compression efficiency. Further, in an example aspect, the compression efficiency calculation means 1014 may acquire information as to whether or not past analysis target data having been compressed at an arbitrary compression ratio could be analyzed in an analysis unit 321 of a second processing unit 30. Then, in a case where it is indicated that the past analysis target data could not be analyzed, the compression efficiency calculation means 1014 may set the compression ratio to a low ratio for need to further improve image quality, and calculate the compression efficiency.

Then, the selection means 101 collects, for each of the at least one piece of analysis target data which has been acquired by each of the at least one first processing unit 20, the compression efficiency which has been determined by the compression efficiency calculation means 1014 in addition to the degree of importance which has been determined by the degree-of-importance determination means 1010 and the computation cost and the communication cost which have been calculated by the processing cost calculation means 1011 for a case where analysis is performed by each of the division methods.

Further, the selection means 101 may determine the degree of priority, for each of the at least one piece of the analysis target data which has been acquired by each of the at least one first processing unit 20, on the basis of the computation cost in a case where the analysis target data is analyzed by the first division method, and the degree of importance and the compression efficiency of the analysis target data. For example, the selection means 101 may determine the degree of priority on the basis of the following equation.

$$Degree of priority = ( α 1 \times degree of importance ) \times ( α 3 / compression efficiency ) / computation cost ( where α 1 and α 3 are each a predetermined value )$$

By determining the degree of priority in this manner, it is possible to preferentially transmit, to the second processing unit 30, analysis target data which has a high compression efficiency and of which cost for data transmission to the second processing unit 30 is low. This consequently allows for efficiently perform analysis.

Further, the selection means 101 selects a division method for analysis target data for which the first division method has not been selected among the at least one piece of analysis target data which has been acquired by each of the at least one first processing unit 20. In an example aspect, the selection means 101 may select the second division method or the third division method further on the basis of the compression efficiency of the analysis target data in addition to the above-described communication quality information of the at least one first processing unit 20.

In the third division method, the communication amount is larger than that in the second division method. However, by selecting the third division method for analysis target data that has a high compression efficiency, it is possible to increase utilization efficiency of radio resources.

Note that the compression efficiency calculation means 1014 may take into account a degree of density of persons or objects in the analysis target data at the time when the compression efficiency is calculated. In an example aspect, the compression efficiency calculation means 1014 may set the compression efficiency to a larger value for the analysis target data in which a larger number of persons or objects to be analyzed are present in a range of a predetermined size (number of pixels). This makes it possible to improve the compression efficiency by transmitting, to the second processing unit 30, data corresponding to a dense region, since such a region can be analyzed even at low resolution.

Further, in calculating the compression efficiency, the compression efficiency calculation means 1014 may take into account the size (number of pixels) of a person or an object to be analyzed in the analysis target data. In an example aspect, the compression efficiency calculation means 1014 may set the compression efficiency to a lower value for the analysis target data in which the size (number of pixels) of the person or object to be analyzed is smaller. In a case where a person or object that appears small is compressed and transmitted to the second processing unit 30 for analysis, there is a high possibility that analysis accuracy is lowered. Therefore, by setting the compression efficiency to a low value, the analysis can be performed in the first processing unit 20 as much as possible.

Note that the selection means 101 may determine the degree of priority, additionally taking into account a degree of danger. In an example aspect, the selection means 101 in accordance with the present example embodiment may further include a degree-of-danger determination means 1013 in accordance with the third example embodiment, and may determine the degree of priority on the basis of the following formula.

$$Degree of priority = ( α 1 \times degree of importance ) \times ( α 2 \times degree of danger ) \times ( α 3 / compression efficiency ) / computation cost ( where α 1 , α 2 , and α 3 are each a predetermined value )$$

Although the above description has described the fourth example embodiment as the processing control system 100, the fourth embodiment can be a processing control apparatus which is obtained by mounting the processing control system 100 in accordance with the fourth example embodiment on one apparatus. Further, the processing control system 100 in accordance with the fourth example embodiment may be operated by a processing control method in accordance with the fourth example embodiment.

### Fifth Example Embodiment

The following description will discuss in detail a fifth example embodiment of the present invention, with reference to drawings. Note that components having the same functions as those described in the first example embodiment are denoted by the same reference numerals, and descriptions thereof will not be repeated.

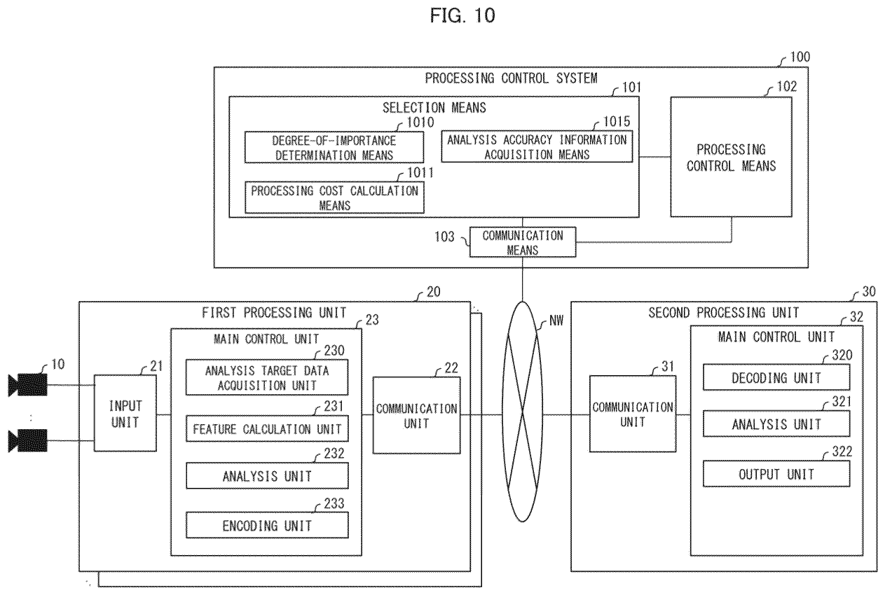

FIG. 10 is a block diagram illustrating configuration examples of a processing control system 100 and of a processing system 1 in accordance with the fifth example embodiment. The selection means 101 in accordance with the present example embodiment includes a degree-of-importance determination means 1010, a processing cost calculation means 1011, and an analysis accuracy information acquisition means 1015. The selection means 101 selects a division method in the following manner, for each of at least one piece of analysis target data which has been acquired by at least one first processing unit 20.

The selection means 101 in accordance with the present example embodiment selects a division method for each piece of the analysis target data by solving a combination optimization problem so that an objective function is maximized. More specifically, the selection means 101 decides, for each piece of the analysis target data, to select a division method or not to perform analysis so that all of constraints below are satisfied and any one of objective functions below is maximized or minimized. This makes it possible to perform efficient analysis in consideration of a whole situation.
(Constraint 1) The total of computation cost in the each of at least one first processing unit 20 is equal to or less than an upper limit based on a computation capacity of that first processing unit 20.
(Constraint 2) For all of the at least one first processing unit 20 that share the same communication line in communication with the second processing unit 30, the total of communication cost of all of the at least one piece of analysis target data is equal to or less than a communication bandwidth of the communication line.
(Objective function 1) Maximize a total of the degree of importance×analysis accuracy of each piece of analysis target data in a case where a division method is selected for each piece of the analysis target data
(Objective function 2) Maximize the number of pieces of analysis target data in which the analysis accuracy is equal to or greater than a specified value (for example, 80%) in a case where a division method is selected for each piece of analysis target data.

The selection means 101 may obtain an optimum solution by searching all options, or may obtain an approximate solution by applying a heuristic algorithm that is generally used. Note that as the analysis accuracy of the analysis target data, it is possible to use an analysis accuracy that is acquired by the analysis accuracy information acquisition means 1015.

In an example aspect, the analysis accuracy information acquisition means 1015 can use, as the analysis accuracy, analysis accuracy information (confidence value) that is obtained in analysis carried out by the trained model. For example, the analysis accuracy information acquisition means 1015 may: assume that analysis target data corresponding to a specific analysis target can be continuously obtained; cause an analysis unit 212 of the first processing unit 20 and an analysis unit 311 of the second processing unit 30 to analyze first several pieces of the analysis target data which correspond to the specific analysis target; acquire analysis accuracy information (confidence value) which is a result of that analysis; and use, as the analysis accuracy information of the analysis target data which corresponds to the specific analysis target, the analysis accuracy information thus obtained. Alternatively, a model for predicting the analysis accuracy from an input that includes the analysis target data and a video compression parameter may be created in advance, and then, the analysis accuracy information acquisition means 1015 may predict the analysis accuracy with use of this model.

It should be noted that in an example aspect, the selection means 101 may not include, in calculation of the objective function, analysis target data corresponding to a particular camera 10, or may reduce weighting of such analysis target data. For example, in a case where a particular camera is covered with water droplets, dust, or the like, in a case where a particular camera is installed in an environment which is so dark that nothing is seen, or in the like case, no analysis of analysis target data corresponding to the camera 10, which is likely to produce a particular result without the analysis, is performed. This allows resources to be allocated to other analysis target data, and can lead to higher efficiency. Note that as to a method of determining whether or not a particular camera is in a situation in which without analysis, a particular result will be likely to be obtained, the method is not particularly limited. For example, the particular camera may be set by determination by a person or may be set in accordance with a result of analysis of a captured image.

Further, in an example aspect, the selection means 101 may switch the objective function depending on a type of action that is desired to be analyzed. For example, in a case where it is desired to detect a dangerous action, the objective function may be set as “degree of importance×analysis accuracy×delay coefficient”, and the delay coefficient may be configured to decrease in a case where a delay until detection becomes equal to or more than a predetermined value. This makes it possible to perform analysis that is suitable for the type of action which is desired to be analyzed.

Further, the analysis accuracy information acquisition means 1015 may estimate an amount of decrease in the analysis accuracy due to a change in division of a process and reflect the amount in the analysis accuracy information. In other words, an analysis engine used by each analysis unit includes an engine that performs analysis on the basis of not only a single video frame but also a change between consecutive video frames. In a case where such an engine is used, frequent change of division of a division between the first processing unit 20 and the second processing unit 30 results in deterioration in the analysis accuracy. By correcting the analysis accuracy information in consideration of such a decrease in the analysis accuracy, it is possible to obtain more accurate analysis accuracy information.

Although the above description has described the fifth example embodiment as the processing control system 100, the fifth embodiment can be a processing control apparatus which is obtained by mounting the processing control system 100 in accordance with the fifth example embodiment on one apparatus. Further, the processing control system 100 in accordance with the fifth example embodiment may be operated by a processing control method in accordance with the fifth example embodiment.

### Variations

The following description will discuss variations that are commonly applicable to the first to fifth example embodiments.

The above description has discussed a configuration in which the processing control system 100 is independent of each of the at least one first processing unit 20 and the second processing unit 30, but each example embodiment is not limited thereto. For example, a part or all of the processing control system 100 may be provided in one or both of the at least one first processing unit 20 and the second processing unit 30 in a distributed manner.

Alternatively, for example, configurations (e.g., the degree-of-importance determination means 1010, the processing cost calculation means 1011, the communication quality information acquisition means 1012, the degree-of-danger determination means 1013, the compression efficiency calculation means 1014, the analysis accuracy information acquisition means 1015, and the like) that the selection means 101 includes may be provided in respectively different apparatuses. Further, apart from these configurations, a main part of the selection means 101 which ultimately makes selection for each piece of the analysis target data may separately exist. For example, at least one selected from the group consisting of the degree-of-importance determination means 1010, the processing cost calculation means 1011, the communication quality information acquisition means 1012, the degree-of-danger determination means 1013, the compression efficiency calculation means 1014, and the analysis accuracy information acquisition means 1015 may be provided in each of the at least one first processing unit 20. Further, the main part of the selection means 101 may be provided in the second processing unit 30.

Further, in a case where it is impossible to uniquely select a division method for each piece of analysis target data (for example, in a case where there are many pieces of analysis target data having the same degree of priority), the selection means 101 may be configured to, for example, sequentially select an analysis target which is to be analyzed by the first processing unit 20 (for which a first division method is selected) (round robin method).

Further, the selection means 101 may make selection of a division method each time analysis target data is acquired. Alternatively, the selection means 101 may periodically carry out a process for selecting a division method and change a processing method in accordance with a change in communication quality, degree of danger, video content, and/or the like.

Further, the selection means 101 may make selection in consideration of an analysis result of past analysis target data which corresponds to the same analysis target. For example, in a case where (i) there is preliminary information indicating that a specific action X will continue (is likely to continue) for a predetermined time or longer and (ii) once, an action X is detected as an analysis result, the selection means 101 may decide not to perform analysis for analysis target data corresponding to the same analysis target.

Further, for example, in a case where the analysis accuracy (confidence value) of an analysis result of analysis target data in the past was high, the selection means 101 may decrease the degree of importance for analysis target data that corresponds to the same analysis target. On the other hand, in a case where the analysis accuracy of the analysis result of the analysis target data in the past was low, the selection means 101 may increase the degree of importance of analysis target data that corresponds to the same analysis target. This is because in a case where the analysis accuracy was high, it is highly likely that the analysis was performed correctly and that the same analysis result is continuing. However, in a case where the analysis accuracy was low, it is highly likely to that the analysis was not performed correctly and that a different analysis result may be obtained.

Further, for analysis target data for which the third division method has been selected, the encoding unit 213 may generate a video in which only a region where an analysis target is present is clipped, and provide the video to the communication unit 22. Alternatively, the encoding unit 213 may generate a video in which image quality of a region other than the region where the analysis target is present is decreased, and provide the video to the communication unit 22.

Further, in an example aspect, the selection means 101 may predict in advance the number of analysis targets (for example, persons) that can be processed in the first processing unit 20, and select a division method in which analysis is performed in the first processing unit 20 as much as possible.

For example, by profiling in advance how many analysis target persons can be analyzed at the same time with use of a computation capacity (computation resource amount) of the first processing unit 20, analysis of persons up to that number of persons is performed in the first processing unit 20 (the first division method is selected) and analysis of persons over that number of persons is offloaded to the second processing unit 30 (the second division method or the third division method is selected).

In this manner, the first processing unit 20 analyzes as many analysis targets as possible. This makes it possible to reduce the processing amount of the second processing unit 30, and consequently to analyze another camera video in the second processing unit 30 or to use the second processing unit 30 for other purposes.

The present disclosure is not limited to the example embodiments described above. The present disclosure can be variously changed, and also encompasses, in its technical scope, any example embodiment obtained by appropriately combining configurations, operations, and/or r processes disclosed in differing example embodiments. Further, the present disclosure also encompasses, in its technical scope, any example embodiment obtained by changing the order of operations and/or processes disclosed in each of differing example embodiments.

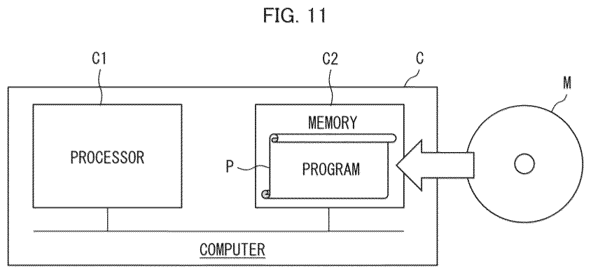

Each configuration in accordance with the first to fifth example embodiments may be implemented by any of (1) one or more pieces of hardware, (2) one or more pieces of software, (3) a combination of hardware and software, and (4) a cloud server. Each apparatus, each function and each process may be realized by at least one computer that has at least one processor and at least one memory. FIG. 11 illustrates an example of such a computer (hereinafter, referred to as “computer C”). For example, a program for implementing the processing control method described in the first to fifth example embodiment may be stored in a memory C2. Then, the processor C1 reads the program P stored in the memory C2 and executes the program P, so that each function described in the first to fifth example embodiments is realized.

The program P includes a group of commands for causing the computer C to execute one or more functions described in the first to fifth example embodiments at the time when the program P is read in the computer C. The program P is stored in the memory C2. The processor C1 can be, for example, a central processing unit (CPU) or the like. The memory C2 can be, for example, a read only memory (ROM), a random access memory (RAM), a flash memory, a solid state drive (SSD), or the like.

The program P can be stored in a non-transitory tangible storage medium M that can be read by the computer C. Examples of the storage medium M encompass a tape, a disk, a card, a semiconductor memory, and a programmable logic circuit. The computer C can obtain the program P via such a storage medium M. The program P can be alternatively transmitted via a transmission medium. Examples of the transmission medium encompass a communication network and a broadcast wave. The computer C can alternatively acquire the program P via the transmission medium.

The present disclosure is not limited to the above-described example embodiments. That is, the present invention can employ, within the scope of the present disclosure, various example aspects that could be understood by a person skilled in the art. Note that the whole or part of the example embodiments disclosed above can also be described as below. Note, however, that the present invention is not limited to example aspects described below.

### Supplementary Note 1

A processing control system that controls at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control system including:
a selection means configured to select, for each of the at least one piece of analysis target data which has been acquired by each of the at least one first processing unit, a division method for analysis of the analysis target data in accordance with a computation capacity of the first processing unit; and
a processing control means configured to control each of the at least one first processing unit and the second processing unit so that each piece of the analysis target data is analyzed according to the division method which has been selected by the selection means.

### Supplementary Note 2

The processing control system according to supplementary note 1, wherein
the selection means selects, for each of the at least one piece of analysis target data which has been acquired by each of the at least one first processing unit, the division method from at least two selected from the group consisting of the following division methods:
a first division method in which the first processing unit is caused to generate an analysis result of the analysis target data;
a second division method in which the first processing unit is caused to calculate a feature of the analysis target data and transmit the feature from the first processing unit to the second processing unit, and the second processing unit is caused to generate the analysis result from the feature; and
a third division method in which the first processing unit is caused to transmit the analysis target data to the second processing unit, and the second processing unit is caused to generate the analysis result from the analysis target data.

### Supplementary note 3

The processing control system according to supplementary note 2, wherein the selection means determines, among the at least one piece of analysis target data which has been acquired by each of the at least one first processing unit, analysis target data for which the first division method is selected in such a manner that a total of computation cost in the first processing unit in a case where the analysis target data is analyzed by the first division method does not exceed an upper limit of the computation cost based on the computation capacity of the first processing unit.

### Supplementary note 4

The processing control system according supplementary note 3, wherein the selection means determines, for each of the at least one piece of analysis target data which has been acquired by each of the at least one first processing unit, a degree of priority on the basis of (i) the computation cost of the analysis target data and (ii) a degree of importance of the analysis target data, and determines, on the basis of the degree of priority which has been determined for each of the at least one piece of the analysis target data, the analysis target data for which the first division method is selected.

### Supplementary note 5

The processing control system according to supplementary note 4, wherein the selection means determines, for each of the at least one piece of analysis target data which has been acquired by each of the at least one first processing unit, the degree of priority further on the basis of at least one selected from the group consisting of a degree of danger indicated by each piece of the analysis target data and a compression efficiency of each piece of the analysis target data.

### Supplementary note 6

The processing control system according to any one of supplementary notes 3 to 5, wherein the selection means selects, for analysis target data for which the first division method has not been selected among the at least one piece of analysis target data which has been acquired by each of the at least one first processing unit, the second division method or the third division method on the basis of communication quality between the first processing unit and the second processing.

### Supplementary note 7

The processing control system according to supplementary note 6, wherein the selection means selects, for analysis target data except for the analysis target data for which the first division method has been selected among the at least one piece of analysis target data which has been acquired by each of the at least one first processing unit, the second division method or the third division method further on the basis of a compression efficiency of the analysis target data.

### Supplementary note 8

The processing control system according to supplementary note 2 or 3, wherein the selection means selects, for each of the at least one piece of analysis target data which has been acquired by each of the at least one first processing unit, the division method on the basis of the following (i) to (iii) in a case where the analysis target data is analyzed by each of the at least two division methods: (i) the computation cost in the first processing unit; (ii) communication cost between the first processing unit and the second processing; and (iii) analysis accuracy of the analysis target data.

### Supplementary note 9

A processing control apparatus that controls at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control apparatus including:
a selection unit configured to select, for each of the at least one piece of analysis target data which has been acquired by each of the at least one first processing unit, a division method for analysis of the analysis target data in accordance with a computation capacity of the first processing unit; and
a processing control unit configured to control each of the at least one first processing unit and the second processing unit so that each piece of the analysis target data is analyzed according to the division method which has been selected by the selection unit.

### Supplementary note 10

The processing control apparatus according to supplementary note 9, wherein the selection unit determines, among the at least one piece of analysis target data which has been acquired by each of the at least one first processing unit, analysis target data for which the first division method is selected in such a manner that a total of computation cost in the first processing unit in a case where the analysis target data is analyzed by the first division method does not exceed an upper limit of the computation cost based on the computation capacity of the first processing unit.

### Supplementary note 11

The processing control apparatus according to supplementary note 10, wherein the selection unit determines, among the at least one piece of analysis target data which has been acquired by each of the at least one first processing unit, analysis target data for which the first division method is selected in such a manner that a total of computation cost in the first processing unit in a case where the analysis target data is analyzed by the first division method does not exceed an upper limit of the computation cost based on the computation capacity of the first processing unit.

### Supplementary note 12

The processing control apparatus according to supplementary note 11, wherein the selection unit determines, for each of the at least one piece of analysis target data which has been acquired by each of the at least one first processing unit, a degree of priority on the basis of (i) the computation cost of the analysis target data and (ii) a degree of importance of the analysis target data, and determines, on the basis of the degree of priority which has been determined for each of the at least one piece of the analysis target data, the analysis target data for which the first division method is selected.

### Supplementary note 13

The processing control apparatus according to supplementary note 12, wherein the selection unit determines, for each of the at least one piece of analysis target data which has been acquired by each of the at least one first processing unit, the degree of priority further on the basis of at least one selected from the group consisting of a degree of danger indicated by each piece of the analysis target data and a compression efficiency of each piece of the analysis target data.

### Supplementary note 14

The processing control apparatus according to any one of supplementary notes 9 to 13, wherein the selection unit selects, for analysis target data except for the analysis target data for which the first division method has been selected among the at least one piece of analysis target data which has been acquired by each of the at least one first processing unit, the second division method or the third division method on the basis of communication quality between the first processing unit and the second processing.

### Supplementary note 15

The processing control apparatus according to supplementary note 14, wherein the selection unit selects, for analysis target data except for the analysis target data for which the first division method has been selected among the at least one piece of analysis target data which has been acquired by each of the at least one first processing unit, the second division method or the third division method further on the basis of a compression efficiency of the analysis target data.

### Supplementary note 16

The processing control apparatus according to supplementary note 9 or 10, wherein, for each of the at least one piece of analysis target data which has been acquired by each of the at least one first processing unit, the selection unit selects the division method on the basis of the following (i) to (iii) in a case where the analysis target data is analyzed by each of the at least two division methods: (i) the computation cost in the first processing unit; (ii) communication cost between the first processing unit and the second processing; and (iii) analysis accuracy of the analysis target data.

### Supplementary note 17

A processing control method for controlling at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control method including:
selecting, for each of the at least one piece of analysis target data which has been acquired by each of the at least one first processing unit, a division method for analysis of the analysis target data in accordance with a computation capacity of the first processing unit; and
controlling each of the at least one first processing unit and the second processing unit so that each piece of the analysis target data is analyzed according to the division method which has been selected.

### Supplementary note 18

The processing control method according to supplementary note 17, wherein for each of the at least one piece of analysis target data which has been acquired by each of the at least one first processing unit, the division method is selected from at least two selected from the group consisting of the following division methods:
a first division method in which the first processing unit is caused to generate an analysis result of the analysis target data;
a second division method in which the first processing unit is caused to calculate a feature of the analysis target data and transmit the feature from the first processing unit to the second processing unit, and the second processing unit is caused to generate the analysis result from the feature; and
a third division method in which the first processing unit is caused to transmit the analysis target data to the second processing unit, and the second processing unit is caused to generate the analysis result from the analysis target data.

### Supplementary note 19

The processing control method according to supplementary note 18, wherein analysis target data for which the first division method is selected, among the at least one piece of analysis target data which has been acquired by each of the at least one first processing unit, is determined in such a manner that a total of computation cost in the first processing unit in a case where the analysis target data is analyzed by the first division method does not exceed an upper limit of the computation cost based on the computation capacity of the first processing unit.

### Supplementary note 20

The processing control method according to supplementary note 19, wherein for each of the at least one piece of analysis target data which has been acquired by each of the at least one first processing unit, a degree of priority is determined on the basis of (i) the computation cost of the analysis target data and (ii) a degree of importance of the analysis target data, and the analysis target data for which the first division method is selected is determined on the basis of the degree of priority which has been determined for each of the at least one piece of the analysis target data.

### Supplementary note 21

The processing control method according to supplementary note 20, wherein for each of the at least one piece of analysis target data which has been acquired by each of the at least one first processing unit, the degree of priority is determined further on the basis of at least one selected from the group consisting of a degree of danger indicated by each piece of the analysis target data and a compression efficiency of each piece of the analysis target data.

### Supplementary note 22

The processing control method according to any one of supplementary notes 19 to 21, wherein for analysis target data except for the analysis target data for which the first division method has been selected among the at least one piece of analysis target data which has been acquired by each of the at least one first processing unit, the second division method or the third division method is selected on the basis of communication quality between the first processing unit and the second processing.

### Supplementary note 23

The processing control method according to supplementary note 22, wherein for analysis target data except for the analysis target data for which the first division method has been selected among the at least one piece of analysis target data which has been acquired by each of the at least one first processing unit, the second division method or the third division method is selected further on the basis of a compression efficiency of the analysis target data.

### Supplementary note 24

The processing control method according to supplementary note 18 or 19, wherein, for each of the at least one piece of analysis target data which has been acquired by each of the at least one first processing unit, the division method is selected on the basis of the following (i) to (iii) in a case where the analysis target data is analyzed by each of the at least two division methods: (i) the computation cost in the first processing unit; (ii) communication cost between the first processing unit and the second processing; and (iii) analysis accuracy of the analysis target data.

### Supplementary note 25

Further, the above processing control system can also be expressed as follow.

A processing control system that controls at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control method including at least one processor,
the at least one processor executing:
a selection process of selecting, for each of the at least one piece of analysis target data which has been acquired by each of the at least one first processing unit, a division method for analysis of the analysis target data in accordance with a computation capacity of the first processing unit; and
a processing control process of controlling each of the at least one first processing unit and the second processing unit so that each piece of the analysis target data is analyzed according to the division method which has been selected in the selection process.

Note that the processing control system may further include at least one memory. In this memory, a program for causing the processor to execute the selection process and the processing control process may be stored. Further, the program may be stored in a non-transitory tangible computer-readable storage medium.

### Supplementary note 26

Further, the above processing control apparatus can also be expressed as follow.

A processing control apparatus that controls at least one first processing unit each of which acquires at least one analysis target data and a second processing unit which is capable of communicating with each of the at least one first processing unit, analysis of the at least one piece of analysis target data being divided between each of the at least one first processing unit and the second processing unit, the processing control apparatus including at least one processor,
the at least one processor executing:
a selection process of selecting, for each of the at least one piece of analysis target data which has been acquired by each of the at least one first processing unit, a division method for analysis of the analysis target data in accordance with a computation capacity of the first processing unit; and
a processing control process of controlling each of the at least one first processing unit and the second processing unit so that each piece of the analysis target data is analyzed according to the division method which has been selected in the selection process.

Note that the processing control apparatus may further include at least one memory. In this memory, a program for causing the processor to execute the selection process and the processing control process may be stored. Further, the program may be stored in a non-transitory tangible computer-readable storage medium.

### REFERENCE SIGNS LIST

1 processing system
10 camera
20 first processing unit
21 input unit
22 communication unit
23 main control unit
30 second processing unit
31 communication unit
32 main control unit
100 processing control system
101 selection means
102 processing control means
103 communication means
200 processing control apparatus
201 selection unit
202 processing control unit
230 analysis target data acquisition unit
231 feature calculation unit
232 analysis unit
233 encoding unit
320 decoding unit
321 analysis unit
322 output unit
1010 degree-of-importance determination means
1011 processing cost calculation means
1012 communication quality information acquisition means
1013 degree-of-danger determination means
1014 compression efficiency calculation means 1014
1015 analysis accuracy information acquisition means

What is claimed is:

1. A processing control system that controls at least one first computer each of which acquires at least one analysis target data and a second computer which is capable of communicating with each of the at least one first computer, analysis of the at least one piece of analysis target data being divided between each of the at least one first computer and the second computer, the processing control system comprising at least one processor,
the at least one processor carrying out:
a selection process of selecting, for each of the at least one piece of analysis target data which has been acquired by each of the at least one first computer, a division method for analysis of the analysis target data in accordance with a computation capacity of the first computer; and
a processing control process of controlling each of the at least one first computer and the second computer so that each piece of the analysis target data is analyzed according to the division method which has been selected in the selection process.

2. The processing control system according to claim 1, wherein
in the selection process, the at least one processor selects, for each of the at least one piece of analysis target data which has been acquired by each of the at least one first computer, the division method from at least two selected from the group consisting of the following division methods:
a first division method in which the first computer is caused to generate an analysis result of the analysis target data;
a second division method in which the first computer is caused to calculate a feature of the analysis target data and transmit the feature from the first computer to the second computer, and the second computer is caused to generate the analysis result from the feature; and
a third division method in which the first computer is caused to transmit the analysis target data to the second computer, and the second computer is caused to generate the analysis result from the analysis target data.

3. The processing control system according to claim 2, wherein in the selection process, the at least one processor determines, among the at least one piece of analysis target data which has been acquired by each of the at least one first computer, analysis target data for which the first division method is selected in such a manner that a total of computation cost in the first computer in a case where the analysis target data is analyzed by the first division method does not exceed an upper limit of the computation cost based on the computation capacity of the first computer.

4. The processing control system according to claim 3, wherein in the selection process, the at least one processor determines, for each of the at least one piece of analysis target data which has been acquired by each of the at least one first computer, a degree of priority on the basis of (i) the computation cost of the analysis target data and (ii) a degree of importance of the analysis target data, and determines, on the basis of the degree of priority which has been determined for each of the at least one piece of the analysis target data, the analysis target data for which the first division method is selected.

5. The processing control system according to claim 4, wherein in the selection process, the at least one processor determines, for each of the at least one piece of analysis target data which has been acquired by each of the at least one first computer, the degree of priority further on the basis of at least one selected from the group consisting of a degree of danger indicated by each piece of the analysis target data and a compression efficiency of each piece of the analysis target data.

6. The processing control system according to claim 3, wherein in the selection process, the at least one processor selects, for analysis target data for which the first division method has not been selected among the at least one piece of analysis target data which has been acquired by each of the at least one first computer, the second division method or the third division method on the basis of communication quality between the first computer and the second computer.

7. The processing control system according to claim 6, wherein in the selection process, the at least one processor selects, for analysis target data except for the analysis target data for which the first division method has been selected among the at least one piece of analysis target data which has been acquired by each of the at least one first computer, the second division method or the third division method further on the basis of a compression efficiency of the analysis target data.

8. A processing control apparatus that controls at least one first computer each of which acquires at least one analysis target data and a second computer which is capable of communicating with each of the at least one first computer, analysis of the at least one piece of analysis target data being divided between each of the at least one first computer and the second computer, the processing control apparatus comprising at least one processor,
the at least one processor carrying out:
a selection process of selecting, for each of the at least one piece of analysis target data which has been acquired by each of the at least one first computer, a division method for analysis of the analysis target data in accordance with a computation capacity of the first computer; and
a processing control process of controlling each of the at least one first computer and the second computer so that each piece of the analysis target data is analyzed according to the division method which has been selected in the selection process.

9. The processing control apparatus according to claim 8, wherein
in the selection process, the at least one processor selects, for each of the at least one piece of analysis target data which has been acquired by each of the at least one first computer, the division method from at least two selected from the group consisting of the following division methods:
a first division method in which the first computer is caused to generate an analysis result of the analysis target data;
a second division method in which the first computer is caused to calculate a feature of the analysis target data and transmit the feature from the first computer to the second computer, and the second computer is caused to generate the analysis result from the feature; and
a third division method in which the first computer is caused to transmit the analysis target data to the second computer, and the second computer is caused to generate the analysis result from the analysis target data.

10. The processing control apparatus according to claim 9, wherein in the selection process, the at least one processor determines, among the at least one piece of analysis target data which has been acquired by each of the at least one first computer, analysis target data for which the first division method is selected in such a manner that a total of computation cost in the first computer in a case where the analysis target data is analyzed by the first division method does not exceed an upper limit of the computation cost based on the computation capacity of the first computer.

11. The processing control apparatus according to claim 10, wherein in the selection process, the at least one processor determines, for each of the at least one piece of analysis target data which has been acquired by each of the at least one first computer, a degree of priority on the basis of (i) the computation cost of the analysis target data and (ii) a degree of importance of the analysis target data, and determines, on the basis of the degree of priority which has been determined for each of the at least one piece of the analysis target data, the analysis target data for which the first division method is selected.

12. The processing control apparatus according to claim 11, wherein in the selection process, the at least one processor determines, for each of the at least one piece of analysis target data which has been acquired by each of the at least one first computer, the degree of priority further on the basis of at least one selected from the group consisting of a degree of danger indicated by each piece of the analysis target data and a compression efficiency of each piece of the analysis target data.

13. The processing control apparatus according to claim 10, wherein in the selection process, the at least one processor selects, for analysis target data except for the analysis target data for which the first division method has been selected among the at least one piece of analysis target data which has been acquired by each of the at least one first computer, the second division method or the third division method on the basis of communication quality between the first computer and the second computer.

14. A processing control method for controlling at least one first computer each of which acquires at least one analysis target data and a second computer which is capable of communicating with each of the at least one first computer, analysis of the at least one piece of analysis target data being divided between each of the at least one first computer and the second computer, the processing control method comprising:
at least one processor selecting, for each of the at least one piece of analysis target data which has been acquired by each of the at least one first computer, a division method for analysis of the analysis target data in accordance with a computation capacity of the first computer; and
the at least one processor controlling each of the at least one first computer and the second computer so that each piece of the analysis target data is analyzed according to the division method which has been selected.

15. The processing control method according to claim 14, wherein
for each of the at least one piece of analysis target data which has been acquired by each of the at least one first computer, the at least one processor selects the division method from at least two selected from the group consisting of the following division methods:
a first division method in which the first computer is caused to generate an analysis result of the analysis target data;
a second division method in which the first computer is caused to calculate a feature of the analysis target data and transmit the feature from the first computer to the second computer, and the second computer is caused to generate the analysis result from the feature; and
a third division method in which the first computer is caused to transmit the analysis target data to the second computer, and the second computer is caused to generate the analysis result from the analysis target data.

16. The processing control method according to claim 15, wherein the at least one processor determines analysis target data for which the first division method is selected, among the at least one piece of analysis target data which has been acquired by each of the at least one first computer, in such a manner that a total of computation cost in the first computer in a case where the analysis target data is analyzed by the first division method does not exceed an upper limit of the computation cost based on the computation capacity of the first computer.

17. The processing control method according to claim 16, wherein for each of the at least one piece of analysis target data which has been acquired by each of the at least one first computer, the at least one processor determines a degree of priority on the basis of (i) the computation cost of the analysis target data and (ii) a degree of importance of the analysis target data, and determines, on the basis of the degree of priority which has been determined for each of the at least one piece of the analysis target data, the analysis target data for which the first division method is selected.

18. The processing control method according to claim 17, wherein for each of the at least one piece of analysis target data which has been acquired by each of the at least one first computer, the at least one processor determines the degree of priority further on the basis of at least one selected from the group consisting of a degree of danger indicated by each piece of the analysis target data and a compression efficiency of each piece of the analysis target data.

19. The processing control method according to claim 16, wherein for analysis target data except for the analysis target data for which the first division method has been selected among the at least one piece of analysis target data which has been acquired by each of the at least one first computer, the at least one processor selects the second division method or the third division method on the basis of communication quality between the first computer and the second computer.

20. The processing control method according to claim 19, wherein for analysis target data except for the analysis target data for which the first division method has been selected among the at least one piece of analysis target data which has been acquired by each of the at least one first computer, the at least one processor selects the second division method or the third division method further on the basis of a compression efficiency of the analysis target data.
